(19) United States
(12) Patent Application Publication
(10) Pub. No.: US 2017/0337636 A1
(43) Pub. Date: Nov. 23, 2017

(54) SYSTEMS AND METHODS FOR PROVIDING WEALTH OPTIMIZATION

(71) Applicant: Elizabeth Fuzaylova, Staten Island, NY (US)

(72) Inventor: Elizabeth Fuzaylova, Staten Island, NY (US)

(21) Appl. No.: 15/157,085

(22) Filed: May 17, 2016

(51) Int. Cl. G06Q 40/00; G06Q 20/40

(52) U.S. Cl. CPC G06Q 40/128; G06Q 20/4016

(57) ABSTRACT

An apparatus may include a computing device including a display, a memory coupled to at least one processor, the at least one processor being configured to: execute a method to anticipate user spending activity based on a plurality of inputs including at least one of a historical purchase history and a location of the user; and providing an alert to be displayed to the user via the computing device to warn the user about an effect of a possible upcoming spending transaction to predefined wealth goals of the user.

### BACKGROUND

### Technical Field

The present disclosure generally relates to electronic devices and more particularly to a method and apparatus for alerting or notifying a user in real-time to events affecting his current and future wealth projections.

### Description of the Related Art

Categorizing and tracking spending transaction and classifying income source would be beneficial so that users could understand how they spend their money and prepare budgets accordingly.

While a variety of personal finance and wealth management services and applications exist, these services and applications do not provide personalized and real-time suggestions in response to location, context, transaction history, etc. Thus, the systems are incapable of proactively guiding a user toward smart spending habits by anticipating user behavior. Rather, the conventionally available applications are only able to provide alerts once a spending activity has already occurred.

Thus, there exists a need for new and improved applications and systems.

### SUMMARY

In an embodiment of the present disclosure, an apparatus may include a computing device including a display, a memory coupled to at least one processor, the at least one processor being configured to: execute a method to anticipate user spending activity based on a plurality of inputs including historical purchase history and a location of the user; and providing an alert to the user via the computing device (e.g., display of the alert, an audible sound, vibration, etc.) to alert or warn the user about an effect of a possible upcoming spending transaction to predefined wealth goals of the user. The alert may be generated based on the location if the user is steadily located within reasonably contained radius for over reasonably short period of time, the system will assume that a user is visiting a specific location and analyzes whether current location is either a store, shopping mall, restaurant or any other service location where that user may incur expenditure.

In an aspect of the present disclosure, a near real-time alert system may be provided where a user continuously benefits from the real-time alerts and notifications from the system which in turn communicates with User's Financial Technology Stack and Personal Financial Data where sophisticated streaming analysis of real-time financial data is being conducted. Alerts and/or suggestions may be generated by a continuous communication with a context analyzer component which performs complex logical operations to predict future or current events that may affect one's wealth and/or financial health. It is to be understood that the term “real-time” more generally mean, “just-in-time”—that is the ability to predict an action based on data analyzed in a particular context as opposed to merely reacting after an action has already been undertaken by a user.

The system may include a server computer to host Alerts/Suggestions Generation Engine and/or a mobile device to collect personal financial data and user's location to transmit them to Alerts/Suggestions Generation Engine.

In another aspect of the present invention, the system further includes a mobile application to get and display alerts and notifications received from Alerts/Suggestions Generation Engine.

The alert may include at least one a current financial balance, end-of-month projected balance, recent transactions, and month-to-date spending. Other events for which the alert may be generated includes, for example, upcoming financial bills, checking account overdraft, a personal credit account showing a transaction that is greater or lesser than a predetermined percentage of the maximum available credit amount (e.g., greater than 30% or less than 10%.) Alerts may also or alternatively be generated in response to an ATM (automated teller machine) fee, a late fee, an international transaction fee, detection of a suspicious transaction (e.g., a transaction that is at least three standard deviations from an average transaction amount over a three-month period of time), a change in the user's credit score or other new credit events from a credit bureau, an inability to update financial information, spending above a predetermined amount or greater than peer (e.g., individuals of similar financial status or capability) spending, a projected negative end of month balance, a calendar event (e.g., taxes), investment events occurrences (e.g., dividend payments), and/or other financial events or payments or bills.

The above and other aspects, features, and advantages of the present disclosure will become apparent from the following description read in conjunction with the accompanying drawings, in which like reference numerals designate the same elements.

### BRIEF DESCRIPTION OF THE DRAWINGS

FIG. 1 is a diagram of an example of a system according to aspects of the present disclosure;

FIG. 2 is a diagram of an example of a client device according to aspects of the present disclosure;

FIG. 3 is a block diagram illustrating a real-time debt avoidance alert system in accordance with the present disclosure;

FIG. 4 is a block diagram illustrating an embodiment of a real-time debt avoidance alert system in accordance with the present disclosure;

FIG. 5 is a block diagram of a further embodiment of a real-time debt avoidance alert system in accordance with the present disclosure;

FIG. 6 is a block diagram illustrating a structural representation of contextual information sources utilized by a real-time debt avoidance alert system in accordance with the present disclosure;

FIG. 7 is a block diagram of components of a real-time debt avoidance alert system in accordance with the present disclosure; and

FIG. 8 is a flowchart of a method for generating alerts and suggestions in accordance with the present disclosure.

### DETAILED DESCRIPTION

Reference will now be made in detail to embodiments of the invention. Wherever possible, same or similar reference numerals are used in the drawings and the description to refer to the same or like parts or steps. The drawings are in simplified form and are provided only for illustrative purposes.

FIG. 1 is a diagram of an example of a system 100 according to aspects of the disclosure. As illustrated, the system 100 may include a commercial service system (CSS) 101, client devices 102-105, and a communications network 106.

According to aspects of the disclosure, the CSS 101 may include one or more servers (e.g., a single server, a server farm, etc.) that are used to provide a commercial service (e.g., a stock portfolio management service). In operation, CSS 101 may maintain a consumer or user profile database (CDB) that includes records for the consumer or users who have joined the commercial service (e.g., the members of the service). Additionally, or alternatively, the CSS may include hardware and/or software for generating alerts such as those generated by the system 300 described herein.

The client devices 102-105 may include any suitable type of computing device. For example, any of the client devices 102-105 may include a smartphone, a desktop computer, a laptop, a gaming console, a digital media player, etc. The communications network 106 may include one or more of a local area network (LAN), a wide area network (WAN), a wireless network (e.g., 802.11, 4G, etc.), and or any other suitable type of network. Each of the client devices 102-105 may be associated with a respective user 102a-105a who is a member of the service.

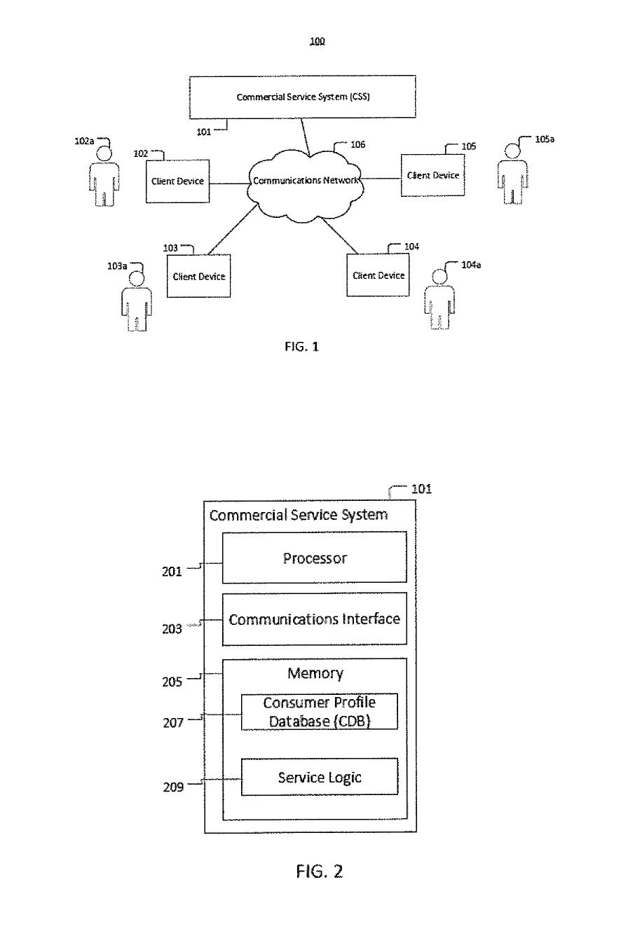

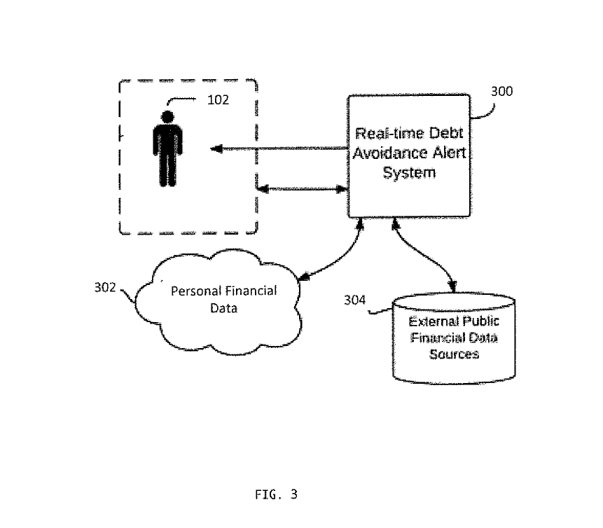

FIG. 2 is a diagram of an example of the commercial service system (CSS) 101, according to aspects of the disclosure. As illustrated, the CSS 101 includes a processor 201, a communications interface 203, and a memory 205. According to aspects of the disclosure, the processor 201 may include any suitable type of processing circuitry, such as a general-purpose processor (e.g., an ARM-based processor), an application-specific integrated circuit (ASIC), or a Field-Programmable Gate Array (FPGA). The communications interface 203 may include any suitable type of communications interface, such as a WiFi interface, an Ethernet interface, a Long-Term Evolution (LTE) interface, a Bluetooth Interface, an Infrared interface, etc. The memory 205 may include any suitable type of volatile and non-volatile memory, such as random-access memory (RAM), read-only memory (ROM), a hard disk (HD), a solid state drive (SSD), a CD-ROM, flash memory, cloud storage, or network accessible storage (NAS). In some implementations, the memory 205 may store a consumer or user profile database (CDB) 207 and service logic 209.

The CDB 207 may include any suitable type of data structure that is arranged to store one or more consumer or user profile records. By way of example, the CDB 207 may include one or more of a file system folder, a relational database, an SQL database, etc. Each profile record may include a data structure containing consumer or user profile information.

The service logic 209 may include one or more of a load balancer, a service frontend that is arranged to interface with instances of a mobile application (e.g. an App) that are executed on the client devices 102-105, and a service backend arranged to provide the particular service. For example, the service backend may be arranged to provide various portfolio management functions, such as buying stock, selling of stock, generating of portfolio reports. Additionally or alternatively, as another example, the service backend may implement an online store, a shopping cart, a billing system, etc.

Although in this example the CSS 101 is presented as an integral device, in some implementations the CSS 101 may be implemented as a network of computers, and/or a server farm. For instance, the CDB 207 and the service logic 209 may be hosted on different computers. Moreover, any of the CDB 207 and the service logic 209 may be hosted on multiple computers.

The CSS 101 may host a real-time debt avoidance alert system 300, which communicates both with client devices, e.g., client device 102. The system 300 may access personal financial data 302 pertaining to the user, as well as external financial data sources 304. The system may receive data from the user's device (e.g., client device 102) regarding the user's use of his or client device. For example, the system may receive indication(s) of what websites the user is visiting, indication(s) of what content the user is viewing on the websites(s), indication(s) of transactions in which the user is currently engaging or has engaged. Additionally or alternatively, the system 300 may receive an indication of the user's current location from the user's client device 102 and/or another source (e.g., a mobile carrier).

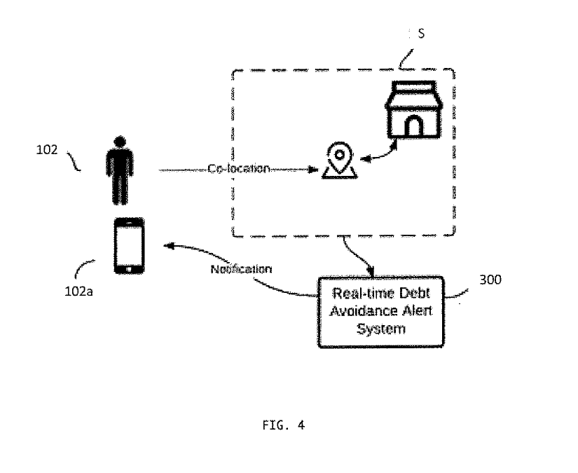

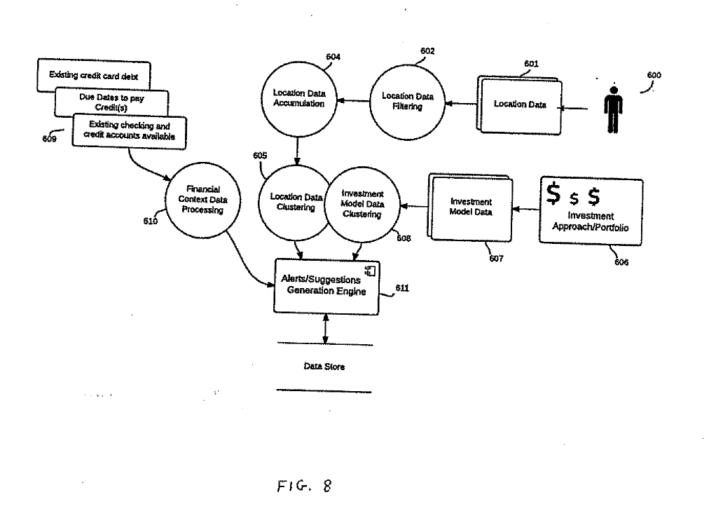

The system 300 may determine or predict based on the context of transactions, e.g., times, locations, and types of purchases, the types of purchases to be made. For example, a user may purchase luggage and sunblock in the winter and may be driving in the direction of an airport, and the system 300 may intuit that the user is traveling somewhere warm. This is an example of an artificial intelligence that utilizes contextual data in near real-time. Similarly, referring now to FIG. 4, a user 102 with a mobile terminal device 102a (e.g., a smartphone) may be at or near a location or store S (e.g., a store) for a predetermined amount of time. The system 300 having received information that the user 102 is at a co-location (i.e., the same location or at a proximate location) as the store S may send a notification to the mobile terminal 102a about the financial situation 102 of the user. For example, the system 300 may notify the user 102 that a given amount of money is available to be spent while remaining on track with a particular financial goal.

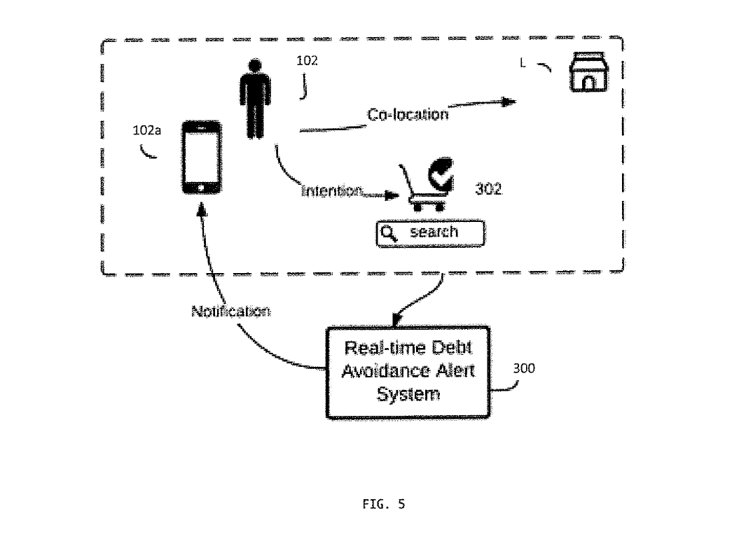

Further, as shown in FIG. 5, a co-location event in conjunction with a search indicating an intention may trigger the system 300 to send a notification to the client device 102a. In particular, the user 102 may receive notification based on the recent online activity, e.g., a search for specific product via build-in web browser of the personal mobile device 102a, and collocation event (i.e., the user 102 being at the store location L). The notification may be transmitted in any suitable manner. For example, the notification may be transmitted as a pop-up window to the user, a Short Messaging Service (SMS) message, and/or any other suitable type of message. In some implementations, the notification may be actionable. For example, it may provide an insight leads to an action (e.g., transfer of money into an account or avoidance or spending or using a credit card with a better rewards structure for a particular transaction) that reduces risk of over expenditure or additional debt and therefore improves wealth.

For example, user 102 may be at an electronics search and may have performed a search 302 on an online store for a television. The system 300 may therefore analyze the context of the search and the colocation event to conclude that the user 102 intends to purchase a television set. This event may trigger the system 300 to send the user 102 a notification as to a discretionary budget for the user 102, thereby preventing the user from purchasing a model television outside of greater than the budget allocated to such discretionary purchases.

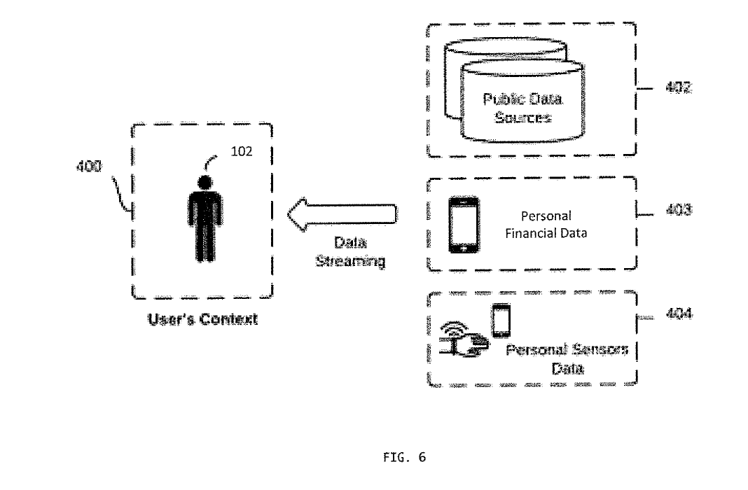

Contextual based analysis may utilize a variety of data. As shown in FIG. 6, the user 102 has a user context 400 that is determined based upon public data sources 402 (e.g., particular locations being associated with particular merchants), personal financial data 403 (e.g., payment transactions for the user 102), and personal sensors data 404 (e.g., GPS sensors, accelerometers, etc.) so that the activity of the user 102 may be determined (e.g., location, movement, etc.). The data may be received from the user's client device and/or any other source that is associated with the user. For example, the context data may be received from the server/system of a bank or another financial institution that services the user's debt and/or credit card.

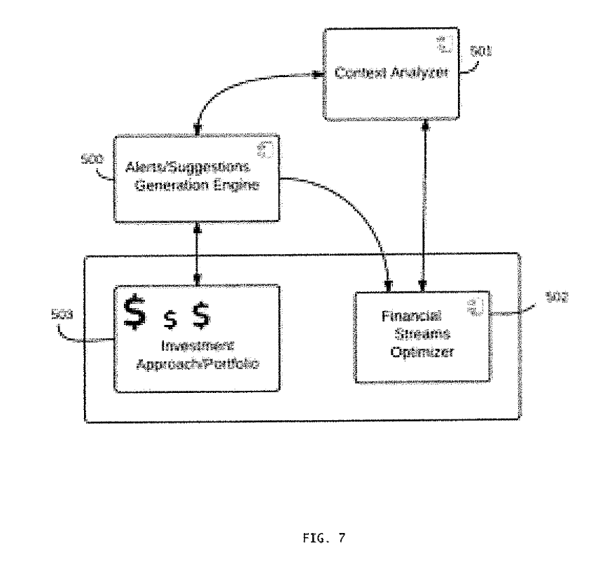

Turning now to FIG. 7, which reflects substantial logical parts of the joint system, it should be noted that financial entities (e.g. debt) optimization logic is represented as a standalone logical component which is leveraged by the core part of the system—Alerts/Suggestions Generation Engine 500. The engine 500 continuously communicates with Context Analyzer Component 501 which perform a sort of Complex Event Processing logic operations. A Context Analyzer Component 501 may have constant communication interface with Financial Streams Optimizer 502. The Investment Approach/Portfolio component 503 which incorporates the generic model of the user's investment approach and portfolio composition. This model generally represents mathematical entity which serves as an input for Alerts/Suggestions Generation Engine 500.

FIG. 8 depicts a data flow diagram for substantial data input parts for the alerts/suggestion generation mechanism a user 102. FIG. 8 illustrates an example of data, e.g., location of the user 102, which may be analyzed based on context. For example, location data 601 may trigger a contextual analysis of the location of the user 102. Such an analysis may include Location Data Event Filtering 602 (e.g., a determination of whether there is a colocation event with a known merchant). This includes Location Data Filtering step 602, Location Data Accumulation 604 and Location Data Clustering 605. Investment Approach/Portfolio component 606 may provide Investment Model Data Structure 607 which may be processed as a main data input for the Investment. Model Data Normalization Step 608. As a third major stream Financial Context Data 609 information is being continuously collected across the system, such as existing credit card debt, existing checking and savings amounts available, due dates to pay credit, etc. and streamed through the Context Financial Data Processing Step 610. All above steps form the data inputs for the Alert/Suggestion Generation Engine 611. Such data may be stored so that future such events may more immediately trigger particular notifications assuming there is a pattern of behavior.

The above-described embodiments are merely exemplary. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

Having described at least one of the preferred embodiments of the present invention with reference to the accompanying drawings, it will be apparent to those of skill in the art that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. An apparatus comprising: a computing device including a display, a memory coupled to at least one processor, the at least one processor being configured to:
execute a method to anticipate user spending activity based on a plurality of inputs including at least one of a historical purchase history and a location of the user; and
providing an alert to be displayed to the user via the computing device to warn the user about an effect of a possible upcoming spending transaction to predefined wealth goals of the user.

2. The system of claim 1, wherein the alert is generated based on the location if the user is steadily located within reasonably contained radius for over reasonably short period of time, the system will assume that a user is visiting a specific location and analyzes whether current location is either a store, shopping mall, restaurant or any other service location where that user may incur expenditure.

3. The apparatus of claim 1, wherein the alert includes at least one a current financial balance, end-of-month projected balance, recent transactions, and month-to-date spending.

4. The apparatus of claim 1, wherein the alert is generated for upcoming financial bills.

5. The apparatus of claim 1, wherein the alert is for checking account overdraft.

6. The apparatus of claim 1, wherein the alert is generated if a personal credit account shows a transaction that is greater or lesser than a predetermined percentage of the maximum available credit amount.

7. The apparatus of claim 6, wherein the predetermined percentage is greater than 30% of the maximum available credit amount.

8. The apparatus of claim 5, wherein the predetermined percentage is less than 10% of the maximum available credit amount.

9. The apparatus of claim 1, wherein the alert is generated in response to at least one of the following: an ATM fee, a late fee, and an international transaction fee.

10. The apparatus of claim 1, wherein the alert is generated in response to a detection of a suspicious transaction.

11. The apparatus of claim 1, wherein the suspicious transaction is a transaction that is of at least three standard deviations from an average transaction amount over a three-month period of time.

12. The apparatus of claim 1, wherein the alert is generated in response to a credit event.

13. The apparatus of claim 1, wherein the alert is generated as a suggestion to the user to take a financial action selected from making a purchase, making an investment, and avoiding a purchase in response to at least one of the historical purchase history and the location of the user.

14. The apparatus of claim 1, wherein the alert is generated if personal financial account information is unable to be updated.

15. The apparatus of claim 1, wherein the alert is generated if spending is above a predetermined spending amount.

16. The apparatus of claim 15, wherein the predetermined spending amount is based on peer spending.

17. The system of claim 1, wherein the alert is generated if a negative end of month balance is projected.

18. The system of claim 1, wherein the alert is generated based on a calendar event.

19. The system of claim 18, wherein the alert is generated if the user's investment portfolio has an event occurrence.

20. There system of claim 19, wherein the event occurrence is at least one of a portfolio rebalancing, payment of a dividend, and a tax loss harvesting event.
